(19) United States
(12) Patent Application Publication
(10) Pub. No.: US 2021/0316650 A1
(43) Pub. Date: Oct. 14, 2021

(54) Seat Engageable Transport Container Assembly

(71) Applicant: Juan Ruvalcaba, Sylmar, CA (US)

(72) Inventor: Juan Ruvalcaba, Sylmar, CA (US)

(21) Appl. No.: 16/843,554

(22) Filed: Apr. 8, 2020

(51) Int. Cl. B60N 3/10; B65D 6/18

(52) U.S. Cl. CPC B60N 3/103; B65D 11/186; B65D 11/184; B60N 3/102

(57) ABSTRACT

A seat engageable transport container assembly for transporting food in a vehicle includes a box, which in turn comprises a bottom panel and a set of four perimeter panels. The bottom panel is rectangular. Each perimeter panel is hingedly engaged to a respective edge of the bottom panel and is selectively fixedly positionable perpendicularly to the bottom panel. The box is selectively positionable in a deployed configuration and a collapsed configuration. In the deployed configuration, a top of the box is open for insertion of an article into the box. In the collapsed configuration, the perimeter panels are positioned proximate to and substantially parallel to the bottom panel. A respective perimeter panel has a pair of apertures positioned therein for insertion of a safety belt of a vehicle to secure the box to a seat. A leveler is engaged to the bottom panel and is used to level the box.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to container assemblies and more particularly pertains to a new container assembly for transporting food in a vehicle.

### (2) Description of Related Art Including Information Disclosed Under 37 CFR 1.97 and 1.98

The prior art relates to container assemblies. Prior art container assemblies positionable on and engageable to a seat of a vehicle may comprise a box having a means of engaging a seatbelt, such as seatbelt openings, a bracket, or a strap. Prior art container assemblies also may comprise a box having straps that are configured to engage a seat of a vehicle,

### BRIEF SUMMARY OF THE INVENTION

An embodiment of the disclosure meets the needs presented above by generally comprising a box, which in turn comprises a bottom panel and a set of four perimeter panels. The bottom panel is rectangular. Each perimeter panel is hingedly engaged to a respective edge of the bottom panel and is selectively fixedly positionable perpendicularly to the bottom panel. The box is selectively positionable in a deployed configuration and a collapsed configuration. In the deployed configuration, a top of the box is open and configured for insertion of an article into the box. In the collapsed configuration, the perimeter panels are positioned proximate to and substantially parallel to the bottom panel. A respective perimeter panel has a pair of apertures positioned therein, which are configured for insertion of a safety belt of a vehicle to secure the box to an associated seat. A leveler is engaged to the bottom panel and is configured to level the box.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric perspective view of a seat engageable transport container assembly according to an embodiment of the disclosure.

FIG. 2 is a bottom isometric perspective view of an embodiment of the disclosure.

FIG. 3 is a collapsed view of an embodiment of the disclosure.

FIG. 4 is a top view of an embodiment of the disclosure.

FIG. 5 is a top view of an embodiment of the disclosure.

FIG. 6 is a side view of an embodiment of the disclosure.

FIG. 7 is a side view of an embodiment of the disclosure.

FIG. 8 is an in-use view of an embodiment of the disclosure.

### DETAILED DESCRIPTION OF THE INVENTION

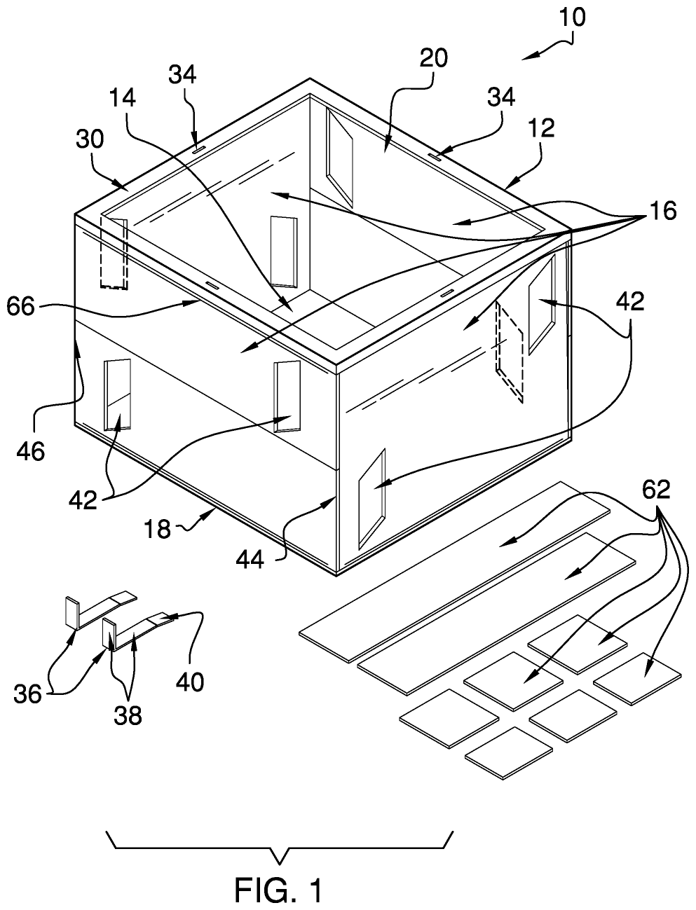

With reference now to the drawings, and in particular to FIGS. 1 through 8 thereof, a new container assembly embodying the principles and concepts of an embodiment of the disclosure and generally designated by the reference numeral 10 will be described.

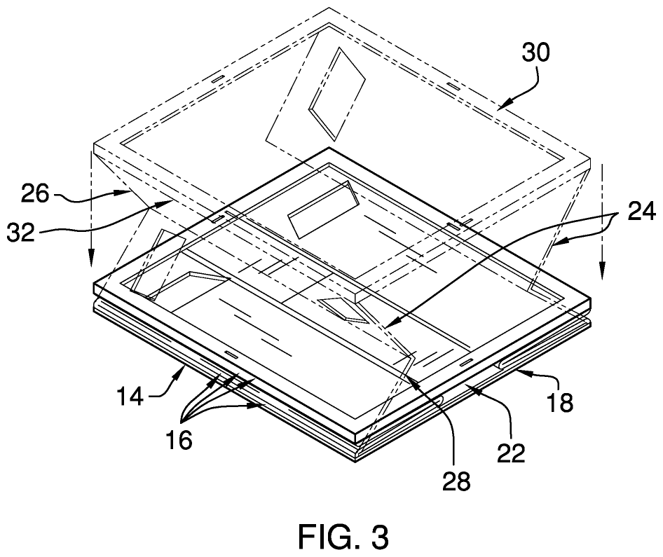

As best illustrated in FIGS. 1 through 8, the seat engageable transport container assembly 10 generally comprises a box 12, which in turn comprises a bottom panel 14 and a set of four perimeter panels 16. The bottom panel 14 is rectangular. Each perimeter panel 16 is hingedly engaged to a respective edge 18 of the bottom panel 14 and is selectively fixedly positionable perpendicularly to the bottom panel 14. The box 12 is selectively positionable in a deployed configuration, as shown in FIG. 1, and a collapsed configuration, as shown in FIG. 3. In the deployed configuration, a top 20 of the box 12 is open and configured for insertion of an article, such as food items for delivery, into the box 12. In the collapsed configuration, the perimeter panels 16 are positioned proximate to and substantially parallel to the bottom panel 14.

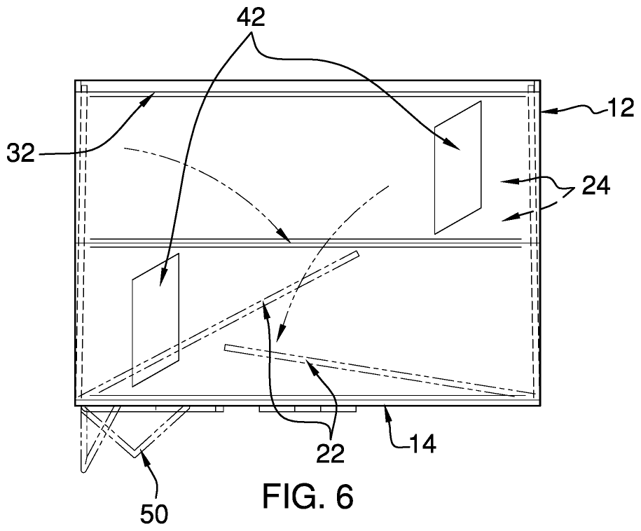

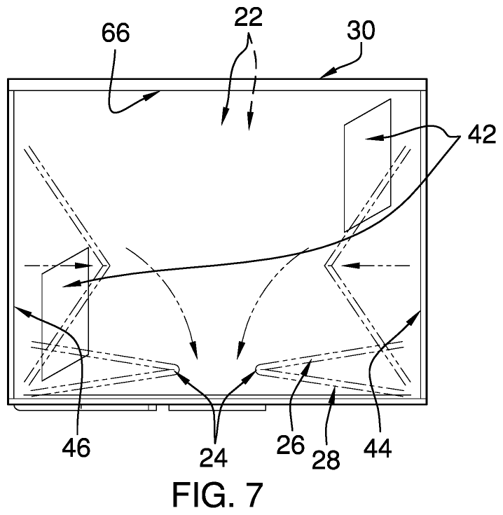

The set of four perimeter panels 16 comprises a pair of first panels 22 and a pair of second panels 24. The pair of first panels 22 are opposingly positioned on the bottom panel 14 and are configured to be sequentially folded toward the bottom panel 14, as shown in FIG. 6. The pair of second panels 24 also is opposingly positioned on the bottom panel 14. Each second panel 24 comprises an upper section 26, which is hingedly engaged to a lower section 28 so that the second panels 24 are foldable toward the first panels 22, as shown in FIG. 7. Each first panel 22 extends between the pair of second panels 24 with the box 12 in the deployed configuration so that the first panel 22 is positioned to support the second panels 24 in a planar configuration.

A rim 30 is hingedly engaged to an upper limit 32 of each second panel 24. The rim 30 is selectively engageable to the pair of first panels 22. The rim 30 has a set of connecting slots 34 positioned therein. Each of a set of brackets 36 is selectively engageable to the rim 30 so that the bracket 36 extends outwardly from the box 12. Respective brackets 36 are configurable to retain an item positioned on the rim 30 that is larger than the top 20 of the box 12, such as a pizza container that is larger than the top 20 and which cannot be inserted into the box 12.

Each bracket 36 comprises a first segment 38, which is L shaped, and a second segment 40. The second segment 40 is configured to be inserted into a respective connecting slot 34 to engage the bracket 36 to the rim 30 with the first segment 38 extending outwardly from the box 12.

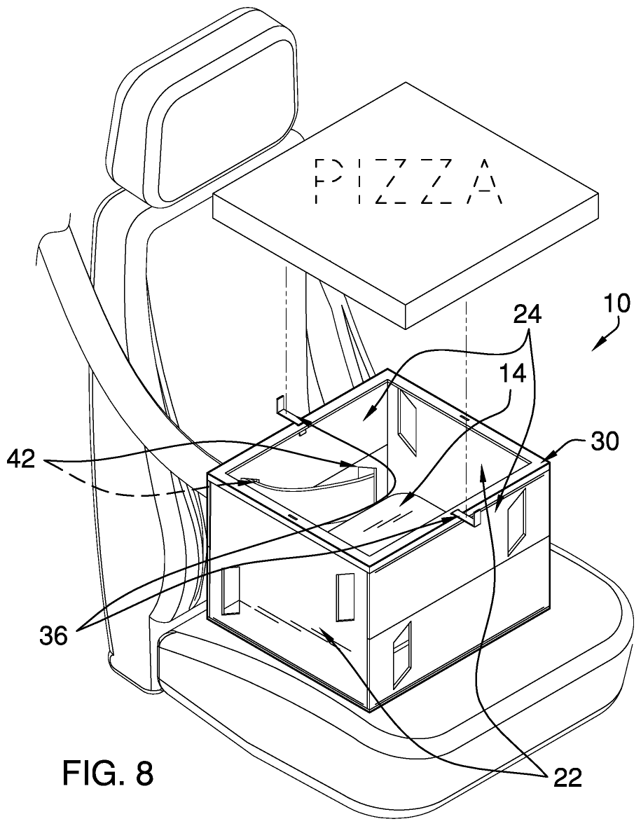

A respective perimeter panel 16 has a pair of apertures 42 positioned therein, which are configured for insertion of a safety belt of a vehicle to secure the box 12 to an associated seat. As shown in FIG. 8, each of the perimeter panels 16 may have a pair of apertures 42 positioned therein to allow any of the perimeter panels 16 to face a backrest of the seat. One of the apertures 42 of the pair of apertures 42 is positioned proximate to and upper edge 66 and an outer edge 44 of the respective perimeter panel 16, while the other of the apertures 42 of the pair of apertures 42 is positioned proximate to the bottom panel 14 and an inner edge 46 of the respective perimeter panel 16.

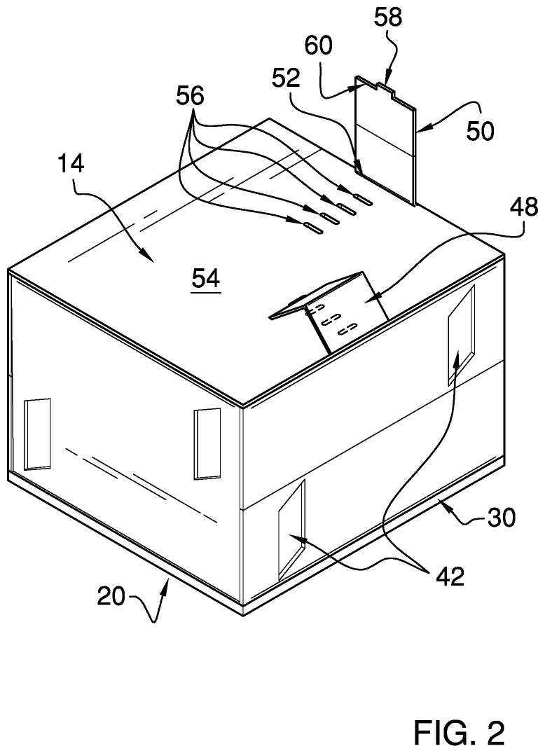

A leveler 48 is engaged to the bottom panel 14 and is configured to level the box 12. The leveler 48 may comprise a bifold panel 50, as shown in FIG. 2, which has a first end 52 that is coupled to a lower face 54 of the bottom panel 14 proximate to a respective edge 18 thereof. The bifold panel 50 is positioned opposite the edge 18 from which extends the respective perimeter panel 16 having the pair of aperture 42 positioned therein.

The bottom panel 14 has a set of adjustment slots 56 positioned in the lower face 54 thereof. A tab 58, which is coupled to and extends from a second end 60 of the bifold panel 50, is positioned to be selectively inserted into a respective adjustment slot 56 of the set of adjustment slots 56. The bifold panel 50 is configured to contact the seat to level the box 12. The present invention anticipates the leveler 48 comprising other leveling means, such as, but not limited to, extendable legs, inflatable bladders, and the like.

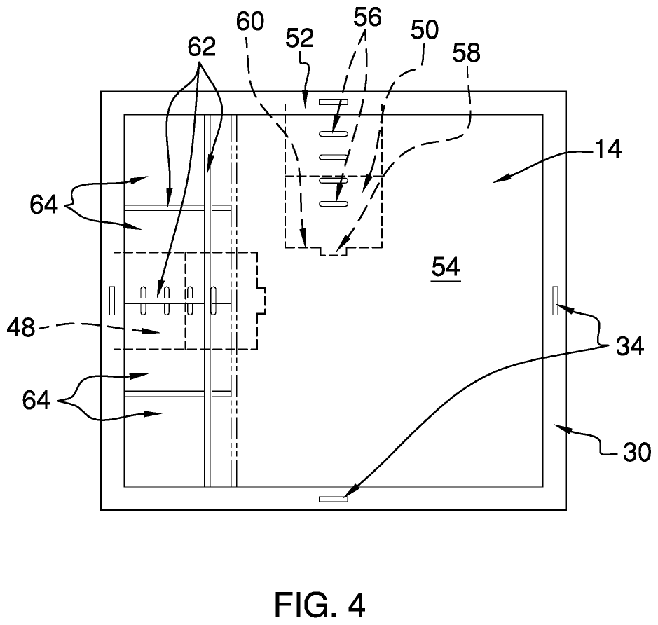

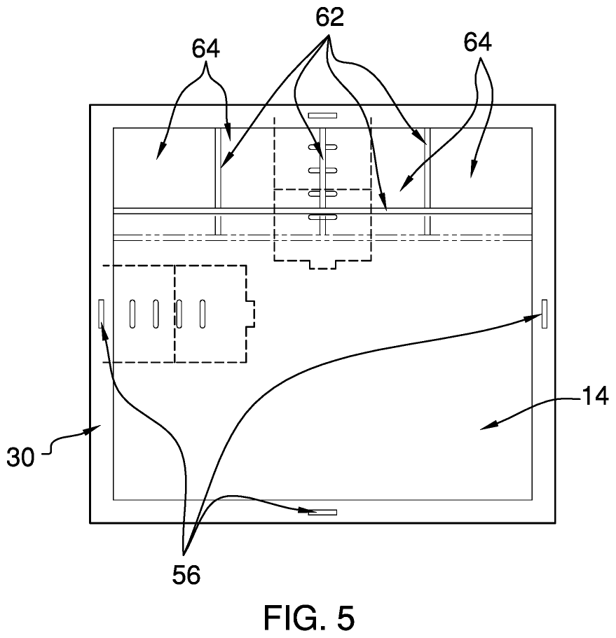

The assembly 10 also comprises a plurality of slats 62, which is selectively engageable to the bottom panel 14. Respective slats 62 are positioned to be engaged to the bottom panel 14 to selectively define a plurality of compartments 64. The compartments 64 are configured to separate articles positioned in the box 12, such as cups, containers, and the like. A variety of slats 62, as shown in FIG. 1, can be used in a variety of combinations to define a variety of compartments 64, as shown in FIGS. 4 and 5, to fit changing requirements of a user. With a box 12 that is not squarely shaped, the slats 62 may comprise a slat 62, which is dimensioned to fit between the first panels 22, as shown in FIG. 4, and a slat 62, which is dimensioned to fit between the second panels 24, as shown in FIG. 5. Respective slats 62 are configured to position as needed between an associated second panel 24 and a slat 62 extending between the pair of first panels 22, as shown in FIG. 4. Additionally, respective slats 62 are configured to position as needed between an associated first panel 22 and a slat 62 extending between the pair of second panels 24, as shown in FIG. 5.

In use, when the box 12 is needed to store articles, the rim 30 is grasped in hands of the user and is motivated distally from the bottom panel 14 so that the second panels 24 extend to the planar configuration. The user then sequentially lifts the first panels 22 so that each is perpendicular to the bottom panel 14 and extends between the second panels 24, thereby frictionally locking the first panels 22 and the second panels 24 in position. The seatbelt is inserted through the pair of apertures 42 to secure the box 12 to the seat. The leveler 48 can be used to level the box 12, as required. The user then can position articles, such as food for delivery, in the box 12 for transport.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the elements is present, unless the context clearly requires that there be only one of the elements.

1. A seat engageable transport container assembly comprising:
a box comprising:
a bottom panel, the bottom panel being rectangular, and
a set of four perimeter panels, each perimeter panel being hingedly engaged to a respective edge of the bottom panel, each perimeter panel being selectively fixedly positionable perpendicularly to the bottom panel, such that the box is selectively positionable in a deployed configuration, wherein a top of the box is open and configured for insertion of an article into the box, and a collapsed configuration, wherein the perimeter panels are positioned proximate to and parallel to the bottom panel, a respective perimeter panel having a pair of apertures positioned therein, wherein the apertures are configured for inserting a safety belt of a vehicle for securing the box to an associated seat, wherein one of the apertures of the pair of apertures is positioned proximate to an upper edge and an outer edge of the respective perimeter panel, wherein the other of the apertures of the pair of apertures is position proximate to the bottom panel and an inner edge of the respective perimeter panel whereby the pair of apertures are arranged to be angled across the respective perimeter panel wherein the pair of apertures are configured to position the safety belt to extend diagonally across the respective perimeter panel; and
a leveler engaged to the bottom panel and being configured for leveling the box.

2. The seat engageable transport container assembly of claim 1, wherein:
one of the apertures of the pair of apertures is positioned proximate to an upper edge and an outer edge of the respective perimeter panel; and
the other of the apertures of the pair of apertures is position proximate to the bottom panel and an inner edge of the respective perimeter panel.

3. The seat engageable transport container assembly of claim 1, further including:
the set of four perimeter panels comprising:
a pair of first panels opposingly positioned on the bottom panel, such that the first panels of the pair of first panels are configured for sequentially folding toward the bottom panel, and
a pair of second panels opposingly positioned on the bottom panel, each second panel comprising an upper section hingedly engaged to a lower section, such that the second panels are foldable toward the first panels; and
a rim hingedly engaged to an upper limit of each second panel.

4. The seat engageable transport container assembly of claim 3, wherein each first panel extends between the pair of second panels with the box in the deployed configuration, such that the first panel is positioned for supporting the second panels in a planar configuration.

5. The seat engageable transport container assembly of claim 3, wherein the rim is selectively engageable to the pair of first panels.

6. The seat engageable transport container assembly of claim further including a set of brackets, each bracket being selectively engageable to the rim such that the bracket extends outwardly from the box, wherein respective brackets are configured for retaining an item positioned on the rim that is larger than the top of the box.

7. The seat engageable transport container assembly of claim 6, wherein:
the rim has a set of connecting slots positioned therein; and
each bracket comprises a first segment and a second segment, the first segment being L-shaped, the second segment being configured for inserting into a respective connecting slot for engaging the bracket to the rim, such that the first segment extends outwardly from the box.

8. The seat engageable transport container assembly of claim 1, wherein:
the bottom panel has a set of adjustment slots positioned in a lower face thereof; and
the leveler comprises:
a bifold panel having a first end coupled to the lower face of the bottom panel proximate to a respective edge thereof, the bifold panel being positioned opposite the edge from which extends the respective perimeter panel having the pair of aperture positioned therein; and
a tab coupled to and extending from a second end of the bifold panel, such that the tab is positioned for selectively inserting into a respective adjustment slot of the set of adjustment slots, wherein the bifold panel is configured for contacting the seat for leveling the box.

9. The seat engageable transport container assembly of claim 1, further including a plurality of slats selectively engageable to the bottom panel, such that respective slats are positioned to be engaged to the bottom panel for selectively defining a plurality of compartments, wherein the compartments are configured for separating articles positioned in the box.

10. A seat engageable transport container assembly comprising:
a box comprising:
a bottom panel, the bottom panel being rectangular, the bottom panel having a set of adjustment slots positioned in a lower face thereof,
a set of four perimeter panels, each perimeter panel being hingedly engaged to a respective edge of the bottom panel, each perimeter panel being selectively fixedly positionable perpendicularly to the bottom panel, such that the box is selectively positionable in a deployed configuration, wherein a top of the box is open and configured for insertion of an article into the box, and a collapsed configuration, wherein the perimeter panels are positioned proximate to and parallel to the bottom panel, a respective perimeter panel having a pair of apertures positioned therein, wherein the apertures are configured for inserting a safety belt of a vehicle for securing the box to an associated seat, one of the apertures of the pair of apertures being positioned proximate to an upper edge and an outer edge of the respective perimeter panel, the other of the apertures of the pair of apertures being position proximate to the bottom panel and an inner edge of the respective perimeter panel whereby the pair of apertures are arranged to be angled across the respective perimeter panel wherein the pair of apertures are configured to position the safety belt to extend diagonally across the respective perimeter panel, the set of four perimeter panels comprising:
a pair of first panels opposingly positioned on the bottom panel, such that the first panels of the pair of first panels are configured for sequentially folding toward the bottom panel, and
a pair of second panels opposingly positioned on the bottom panel, each second panel comprising an upper section hingedly engaged to a lower section, such that the second panels are foldable toward the first panels, each first panel extending between the pair of second panels with the box in the deployed configuration, such that the first panel is positioned for supporting the second panels in a planar configuration;
a leveler engaged to the bottom panel and being configured for leveling the box, the leveler comprising:
a bifold panel having a first end coupled to the lower face of the bottom panel proximate to a respective edge thereof, the bifold panel being positioned opposite the edge from which extends the respective perimeter panel having the pair of aperture positioned therein, and
a tab coupled thereto and extending from a second end thereof, such that the tab is positioned for selectively inserting into a respective adjustment slot of the set of adjustment slots, wherein the bifold panel is configured for contacting the seat for leveling the box;
a rim hingedly engaged to an upper limit of each second panel, the rim being selectively engageable to the pair of first panels, the rim having a set of connecting slots positioned therein;
a set of brackets, each bracket being selectively engageable to the rim such that the bracket extends outwardly from the box, wherein respective brackets are configured for retaining an item positioned on the rim that is larger than the top of the box, each bracket comprising a first segment and a second segment, the first segment being L-shaped, the second segment being configured for inserting into a respective connecting slot for engaging the bracket to the rim, such that the first segment extends outwardly from the box; and
a plurality of slats selectively engageable to the bottom panel, such that respective slats are positioned to be engaged to the bottom panel for selectively defining a plurality of compartments, wherein the compartments are configured for separating articles positioned in the box.
